(19) United States
(12) Patent Application Publication
(10) Pub. No.: US 2021/0318935 A1
(43) Pub. Date: Oct. 14, 2021

(54) METHOD OF USING STATISTICAL BACKUP VALIDATION FOR PREDICTABLE DATABASE RESTORE TIME

(71) Applicant: salesforce.com, inc., San Francisco, CA (US)

(72) Inventors: Lawrence JACOBS, Foster City, CA (US); Karthik Mohan SUBRAMANIAN, Sunnyvale, CA (US); Jeffrey ZOCH, San Francisco, CA (US); Ted LIU, Los Altos, CA (US); Youngjin YU, Cupertino, CA (US); Yeshwant Sai MADANAGOPAL, Fremont, CA (US)

(21) Appl. No.: 16/843,574

(22) Filed: Apr. 8, 2020

(51) Int. Cl. G06F 11/14; G06F 16/17; G06F 16/182

(52) U.S. Cl. CPC G06F 11/1464; G06F 11/1461; G06F 11/1469; G06F 2201/80; G06F 16/1734; G06F 16/182; G06F 11/1451

(57) ABSTRACT

System and methods are described for restoring a database by receiving a request to restore a database in a cloud computing environment, generating a restore plan for the database based at least in part on previously stored database restore outcomes and error probabilities of full backups, incremental backups, and redo logs, restoring the database from an archive according to the restore plan, and storing an outcome of the database restore.

### COPYRIGHT NOTICE/PERMISSION

Portions of the disclosure of this patent document may contain material that is subject to copyright protection. The copyright owner has no objection to the reproduction by anyone of the patent document or the patent disclosure as it appears in the Patent and Trademark Office patent file or records, but otherwise reserves all copyright rights whatsoever. The copyright notice applies to all data as described below, and in the accompanying drawings hereto, as well as to any software described below: Copyright © 2020, salesforce.com, inc., All Rights Reserved.

### TECHNICAL FIELD

One or more implementations relate to cloud computing environments, and more specifically to restoration of databases in a distributed system of a cloud computing environment.

### BACKGROUND

“Cloud computing” services provide shared resources, software, and information to computers and other devices upon request or on demand. Cloud computing typically involves the over-the-Internet provision of dynamically scalable and often virtualized resources. Technological details can be abstracted from end-users, who no longer have need for expertise in, or control over, the technology infrastructure “in the cloud” that supports them. In cloud computing environments, software applications can be accessible over the Internet rather than installed locally on personal or in-house computer systems. Some of the applications or on-demand services provided to end-users can include the ability for a user to create, view, modify, store and share documents and other files.

The size of data used in the cloud is growing exponentially and maintaining the customer's data availability and consistency for cloud-based Software-as-a-Service (SaaS) applications is a major challenge. When providing a SaaS-based application in a cloud computing environment, ensuring high availability of customer data and meeting the service level agreements (SLAs) of the customers is a priority.

Database backups contain a collection of backup files that are archived and later selectively used to reinstate a database to a specific point in time. The database restoration process can typically be performed in different ways with various sets of backup files. Each database restoration process has trade-offs of operational speed, storage space needed, and operational complexity. Adding to the complexity is an observation that some database restoration operations may introduce corruption into the restored database. If any of the backup files in one database restoration process is corrupted, an alternative database restoration process should be used with a different set of backup files. Some database restoration processes are much faster than others, but a result of a database restoration process is only valid if the restored files are not corrupt. In large scale cloud computing, restoration of large databases can take up to multiple days with a fast process and can take up to multiple weeks with a slow process. Choosing the faster process for a database restoration can improve the ability of a cloud computing provider to recover from failures. However, in many cases it is not known if a backup file is corrupt until the end of the database restoration process.

### BRIEF DESCRIPTION OF THE DRAWINGS

The included drawings are for illustrative purposes and serve to provide examples of possible structures and operations for the disclosed inventive systems, apparatus, methods, and computer-readable storage media. These drawings in no way limit any changes in form and detail that may be made by one skilled in the art without departing from the spirit and scope of the disclosed implementations.

FIG. 1A illustrates an example computing environment of an on-demand database service according to some embodiments.

FIG. 1B illustrates example implementations of elements of FIG. 1A and example interconnections between these elements according to some embodiments.

FIG. 2A illustrates example architectural components of an on-demand database service environment according to some embodiments.

FIG. 2B illustrates example architectural components of an on-demand database service environment according to some embodiments.

FIG. 3 is a diagrammatic representation of a machine in the exemplary form of a computer system within which one or more embodiments may be carried out.

FIG. 4 is a diagram of an example database restore system according to some embodiments.

FIG. 5 is a flow diagram of example processing in a database restore system according to some embodiments.

### DETAILED DESCRIPTION

Conventional database (DB) backup solutions use various techniques to archive DB data in external repositories. The techniques vary in scope (restore from full copies vs. incremental portions) and form (restore from transaction logs vs. data blocks). None of the known solutions consider the probability or impact of a file that is to be restored becoming corrupt during the restore process. Embodiments of the present invention overcome this and other disadvantages by introducing the probability of file corruption in the process of performing database backups and restores to optimize the time required to provide a correctly restored database (e.g., one without any corrupted files). In one embodiment of this invention, a process is used that incorporates analysis of restore operation failure probability when determining the most expedient database restoration process.

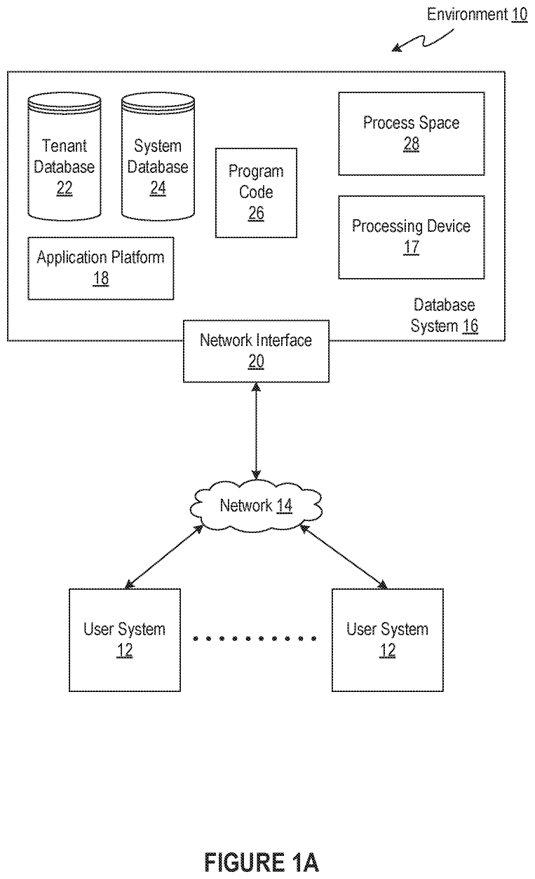

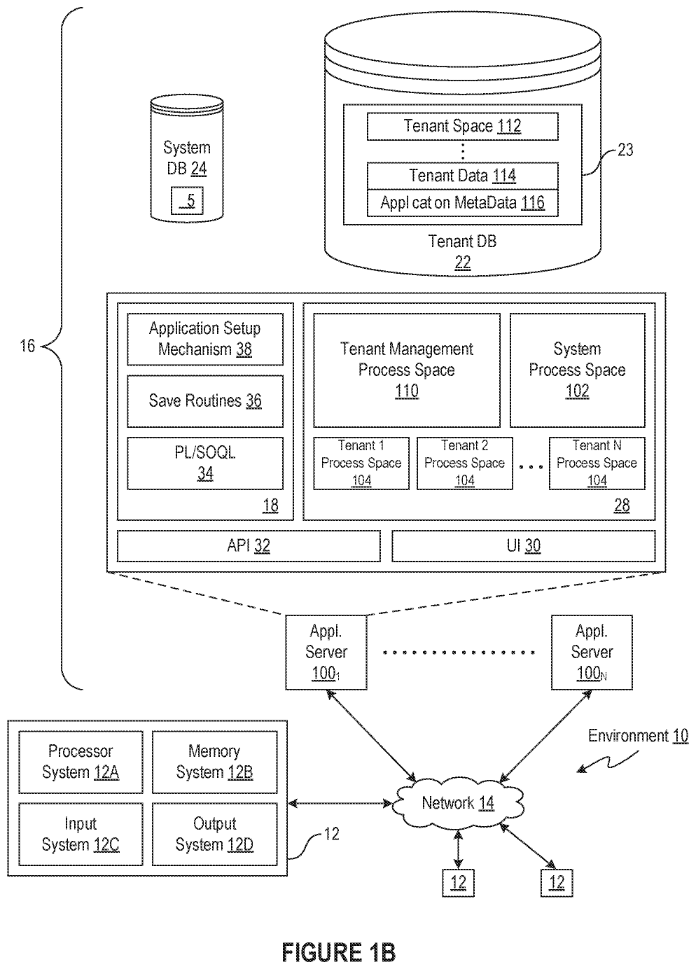

FIG. 1A illustrates a block diagram of an example of a cloud computing environment 10 in which an on-demand database service can be used in accordance with some implementations. Environment 10 includes user systems 12 (e.g., customer's computing systems), a network 14, a database system 16 (also referred to herein as a “cloud-based system” or a “cloud computing system”), a processing device 17, an application platform 18, a network interface 20, a tenant database 22 for storing tenant data (such as data sets), a system database 24 for storing system data, program code 26 for implementing various functions of the database system 16 (including a visual data cleaning application), and process space 28 for executing database system processes and tenant-specific processes, such as running applications for customers as part of an application hosting service. In some other implementations, environment 10 may not have all these components or systems, or may have other components or systems instead of, or in addition to, those listed above. In some embodiments, tenant database 22 is a shared storage.

In some implementations, environment 10 is a computing environment in which an on-demand database service (such as a distributed search application) exists. An on-demand database service, such as that which can be implemented using database system 16, is a service that is made available to users outside an enterprise (or enterprises) that owns, maintains, or provides access to database system 16. As described above, such users generally do not need to be concerned with building or maintaining database system 16. Instead, resources provided by database system 16 may be available for such users' use when the users need services provided by database system 16; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a large number of customers, and a given database table may store rows of data for a potentially much larger number of customers. A database image can include one or more database objects. A relational database management system (RDBMS) or the equivalent can execute storage and retrieval of information against the database object(s).

Application platform 18 can be a framework that allows the applications of database system 16 to execute, such as the hardware or software infrastructure of database system 16. In some implementations, application platform 18 enables the creation, management and execution of one or more applications developed by the provider of the on-demand database service, users accessing the on-demand database service via user systems 12, or third-party application developers accessing the on-demand database service via user systems 12.

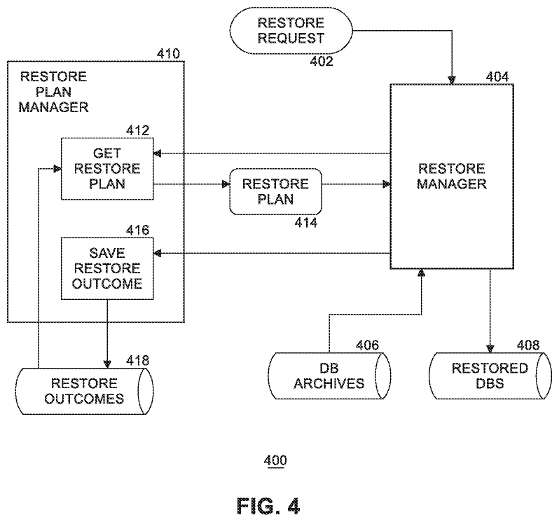

In some embodiments, application platform 18 includes restore manager 404 and restore plan manager 410 (as shown in FIG. 4 and described below) to provide DB restore operations for one or more of tenant database 22 and/or system database 24. In an embodiment, a DB restore operation is requested by a user system 12 to restore one or more files in tenant database 22 from a backup copy of the one or more files.

In some implementations, database system 16 implements a web-based customer relationship management (CRM) system. For example, in some such implementations, database system 16 includes application servers configured to implement and execute CRM software applications as well as provide related data, code, forms, renderable web pages, and documents and other information to and from user systems 12 and to store to, and retrieve from, a database system related data, objects, and World Wide Web page content. In some MTS implementations, data for multiple tenants may be stored in the same physical database object in tenant database 22. In some such implementations, tenant data is arranged in the storage medium(s) of tenant database 22 so that data of one tenant is kept logically separate from that of other tenants so that one tenant does not have access to another tenant's data, unless such data is expressly shared. Database system 16 also implements applications other than, or in addition to, a CRM application. For example, database system 16 can provide tenant access to multiple hosted (standard and custom) applications, including a CRM application. User (or third-party developer) applications, which may or may not include CRM, may be supported by application platform 18. Application platform 18 manages the creation and storage of the applications into one or more database objects and the execution of the applications in one or more virtual machines in the process space of database system 16.

According to some implementations, each database system 16 is configured to provide web pages, forms, applications, data, and media content to user (client) systems 12 to support the access by user systems 12 as tenants of database system 16. As such, database system 16 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application, such as an object-oriented database management system (OODBMS), a relational database management system (RDBMS), or an unstructured DB such as “noSQL” as is well known in the art. It should also be understood that “server system”, “server”, “server node”, and “node” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

Network 14 can be or include any network or combination of networks of systems or devices that communicate with one another. For example, network 14 can be or include any one or any combination of a local area network (LAN), wide area network (WAN), telephone network, wireless network, cellular network, point-to-point network, star network, token ring network, hub network, or other appropriate configuration. Network 14 can include a Transfer Control Protocol and Internet Protocol (TCP/IP) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

User systems 12 (e.g., operated by customers) can communicate with database system 16 using TCP/IP and, at a higher network level, other common Internet protocols to communicate, such as the Hyper Text Transfer Protocol (HTTP), Hyper Text Transfer Protocol Secure (HTTPS), File Transfer Protocol (FTP), Apple File Service (AFS), Wireless Application Protocol (WAP), Secure Sockets layer (SSL) etc. In an example where HTTP is used, each user system 12 can include an HTTP client commonly referred to as a “web browser” or simply a “browser” for sending and receiving HTTP signals to and from an HTTP server of the database system 16. Such an HTTP server can be implemented as the sole network interface 20 between database system 16 and network 14, but other techniques can be used in addition to or instead of these techniques. In some implementations, network interface 20 between database system 16 and network 14 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

User systems 12 can be implemented as any computing device(s) or other data processing apparatus or systems usable by users to access database system 16. For example, any of user systems 12 can be a desktop computer, a work station, a laptop computer, a tablet computer, a handheld computing device, a mobile cellular phone (for example, a “smartphone”), or any other Wi-Fi-enabled device, WAP-enabled device, or other computing device capable of interfacing directly or indirectly to the Internet or other network. When discussed in the context of a user, the terms “user system,” “user device,” and “user computing device” are used interchangeably herein with one another and with the term “computer.” As described above, each user system 12 typically executes an HTTP client, for example, a web browsing (or simply “browsing”) program, such as a web browser based on the WebKit platform, Microsoft's Internet Explorer browser, Netscape's Navigator browser, Opera's browser, Mozilla's Firefox browser, Google's Chrome browser, or a WAP-enabled browser in the case of a cellular phone, personal digital assistant (PDA), or other wireless device, allowing a user (for example, a subscriber of on-demand services provided by database system 16) of user system 12 to access, process, and view information, pages, and applications available to it from database system 16 over network 14.

Each user system 12 also typically includes one or more user input devices, such as a keyboard, a mouse, a trackball, a touch pad, a touch screen, a pen or stylus, or the like, for interacting with a graphical user interface (GUI) provided by the browser on a display (for example, a monitor screen, liquid crystal display (LCD), light-emitting diode (LED) display, etc.) of user system 12 in conjunction with pages, forms, applications, and other information provided by database system 16 or other systems or servers. For example, the user interface device can be used to access data and applications hosted database system 16, and to perform searches on stored data, or otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 12 may differ in their respective capacities, and the capacity of a particular user system 12 can be entirely determined by permissions (permission levels) for the current user of such user system. For example, where a salesperson is using a particular user system 12 to interact with database system 16, that user system can have the capacities allotted to the salesperson. However, while an administrator is using that user system 12 to interact with database system 16, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 12 and some or all of its components are operator-configurable using applications, such as a browser, including computer code executed using a central processing unit (CPU), such as a Core® processor commercially available from Intel Corporation or the like. Similarly, database system 16 (and additional instances of an MTS, where more than one is present) and all of its components can be operator-configurable using application(s) including computer code to run using processing device 17, which may be implemented to include a CPU, which may include an Intel Core® processor or the like, or multiple CPUs. Each CPU may have multiple processing cores.

Database system 16 includes non-transitory computer-readable storage media having instructions stored thereon that are executable by or used to program a server or other computing system (or collection of such servers or computing systems) to perform some of the implementation of processes described herein. For example, program code 26 can include instructions for operating and configuring database system 16 to intercommunicate and to process web pages, applications, and other data and media content as described herein. In some implementations, program code 26 can be downloadable and stored on a hard disk, but the entire program code, or portions thereof, also can be stored in any other volatile or non-volatile memory medium or device as is well known, such as a read-only memory (ROM) or random-access memory (RAM), or provided on any media capable of storing program code, such as any type of rotating media including floppy disks, optical discs, digital video discs (DVDs), compact discs (CDs), micro-drives, magneto-optical discs, magnetic or optical cards, nanosystems (including molecular memory integrated circuits), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, virtual private network (VPN), local area network (LAN), etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™, JavaScript, ActiveX, any other scripting language, such as VB Script, and many other programming languages as are well known.

FIG. 1B illustrates a block diagram of example implementations of elements of FIG. 1A and example interconnections between these elements according to some implementations. That is, FIG. 1B also illustrates environment 10, but in FIG. 1B, various elements of database system 16 and various interconnections between such elements are shown with more specificity according to some more specific implementations. In some implementations, database system 16 may not have the same elements as those described herein or may have other elements instead of, or in addition to, those described herein.

In FIG. 1B, user system 12 includes a processor system 12A, a memory system 12B, an input system 12C, and an output system 12D. The processor system 12A can include any suitable combination of one or more processors. The memory system 12B can include any suitable combination of one or more memory devices. The input system 12C can include any suitable combination of input devices, such as one or more touchscreen interfaces, keyboards, mice, trackballs, scanners, cameras, or interfaces to networks. The output system 12D can include any suitable combination of output devices, such as one or more display devices, printers, or interfaces to networks.

In FIG. 1B, network interface 20 is implemented as a set of HTTP application servers 100₁-100_{N}. Each application server 100, also referred to herein as an “app server,” is configured to communicate with tenant database 22 and tenant data 23 stored therein, as well as system database 24 and system data 25 stored therein, to serve requests received from user systems 12. Tenant data 23 can be divided into individual tenant storage spaces 112, which can be physically or logically arranged or divided. Within each tenant storage space 112, tenant data 114 and application metadata 116 can similarly be allocated for each user. For example, a copy of a user's most recently used (MRU) items can be stored in tenant data 114. Similarly, a copy of MRU items for an entire organization that is a tenant can be stored to tenant space 112.

Database system 16 of FIG. 1B also includes a user interface (UI) 30 and an application programming interface (API) 32. Process space 28 includes system process space 102, individual tenant process spaces 104 and a tenant management process space 110. Application platform 18 includes an application setup mechanism 38 that supports application developers' creation and management of applications. Such applications and others can be saved as metadata into tenant database 22 by save routines 36 for execution by subscribers as one or more tenant process spaces 104 managed by tenant management process space 110, for example. Invocations to such applications can be coded using procedural language for structured query language (PL/SQL) 34, which provides a programming language style interface extension to the API 32. A detailed description of some PL/SQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, issued on Jun. 1, 2010, and hereby incorporated by reference herein in its entirety and for all purposes. Invocations to applications can be detected by one or more system processes, which manage retrieving application metadata 116 for the subscriber making the invocation and executing the metadata as an application in a virtual machine.

Each application server 100 can be communicably coupled with tenant database 22 and system database 24, for example, having access to tenant data 23 and system data 25, respectively, via a different network connection. For example, one application server 100₁ can be coupled via the network 14 (for example, the Internet), another application server 1002 can be coupled via a direct network link, and another application server 100_{N} can be coupled by yet a different network connection. Transfer Control Protocol and Internet Protocol (TCP/IP) are examples of typical protocols that can be used for communicating between application servers 100 and database system 16. However, it will be apparent to one skilled in the art that other transport protocols can be used to optimize database system 16 depending on the network interconnections used.

In some implementations, each application server 100 is configured to handle requests for any user associated with any organization that is a tenant of database system 16. Because it can be desirable to be able to add and remove application servers 100 from the server pool at any time and for various reasons, in some implementations there is no server affinity for a user or organization to a specific application server 100. In some such implementations, an interface system implementing a load balancing function (for example, an F5 Big-IP load balancer) is communicably coupled between application servers 100 and user systems 12 to distribute requests to application servers 100. In one implementation, the load balancer uses a least-connections algorithm to route user requests to application servers 100. Other examples of load balancing algorithms, such as round robin and observed-response-time, also can be used. For example, in some instances, three consecutive requests from the same user could hit three different application servers 100, and three requests from different users could hit the same application server 100. In this manner, by way of example, database system 16 can be a multi-tenant system in which database system 16 handles storage of, and access to, different objects, data, and applications across disparate users and organizations.

In some embodiments, at least one application server 100₁ . . . 100_{N} includes restore manager 404 and restore plan manager 410 (as shown in FIG. 4 and described below) to provide DB restore operations for one or more of tenant database 22 and/or system database 24. In an embodiment, a DB restore operation is requested by a user system 12 to restore one or more files in tenant database 22 from a backup copy of the one or more files.

In one example storage use case, one tenant can be a company that employs a sales force where each salesperson uses database system 16 to manage aspects of their sales. A user can maintain contact data, leads data, customer follow-up data, performance data, goals and progress data, etc., all applicable to that user's personal sales process (for example, in tenant database 22). In an example of a MTS arrangement, because all of the data and the applications to access, view, modify, report, transmit, calculate, etc., can be maintained and accessed by a user system 12 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed database system 16 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, database system 16 also can maintain system level data usable by multiple tenants or other data. Such system level data can include industry reports, news, postings, and the like that are sharable among tenants.

In some implementations, user systems 12 (which also can be client systems) communicate with application servers 100 to request and update system-level and tenant-level data from database system 16. Such requests and updates can involve sending one or more queries to tenant database 22 or system database 24. Database system 16 (for example, an application server 100 in database system 16) can automatically generate one or more SQL statements (for example, one or more SQL queries) designed to access the desired information. System database 24 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects, or may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, issued on Aug. 17, 2010, and hereby incorporated by reference herein in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

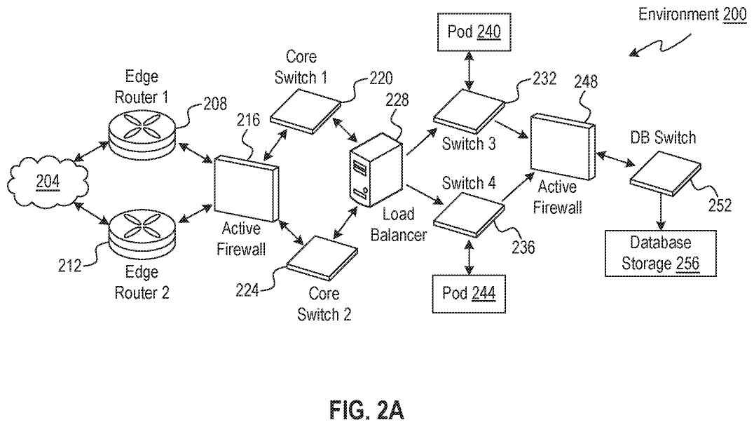

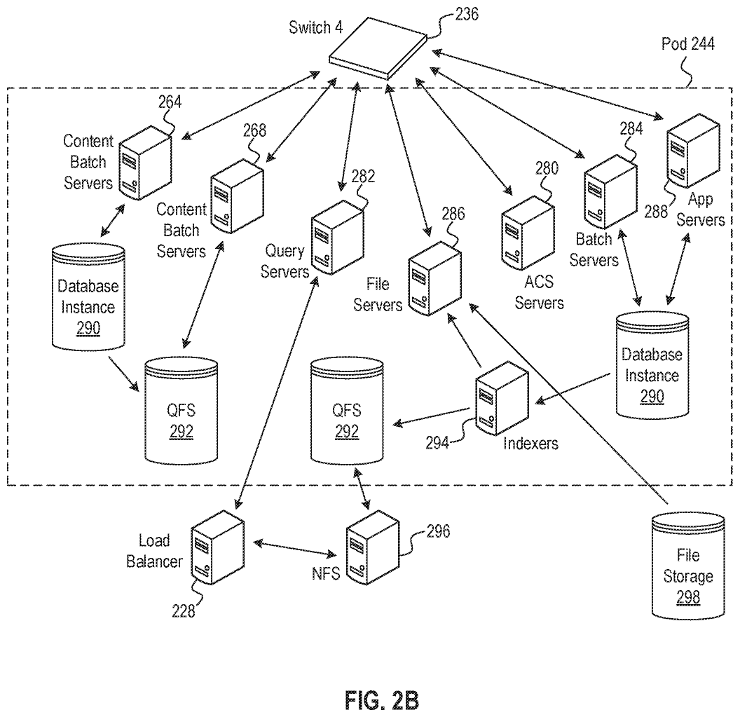

FIG. 2A shows a system diagram illustrating example architectural components of an on-demand database service environment 200 according to some implementations. A client machine communicably connected with the cloud 204, generally referring to one or more networks in combination, as described herein, can communicate with the on-demand database service environment 200 via one or more edge routers 208 and 212. A client machine can be any of the examples of user systems 12 described above. The edge routers can communicate with one or more core switches 220 and 224 through a firewall 216. The core switches can communicate with a load balancer 228, which can distribute server load over different pods, such as the pods 240 and 244. Pods 240 and 244, which can each include one or more servers or other computing resources, can perform data processing and other operations used to provide on-demand services. Communication with the pods can be conducted via pod switches 232 and 236. Components of the on-demand database service environment can communicate with database storage 256 through a database firewall 248 and a database switch 252.

As shown in FIGS. 2A and 2B, accessing an on-demand database service environment can involve communications transmitted among a variety of different hardware or software components. Further, the on-demand database service environment 200 is a simplified representation of an actual on-demand database service environment. For example, while only one or two devices of each type are shown in FIGS. 2A and 2B, some implementations of an on-demand database service environment can include anywhere from one to many devices of each type. Also, the on-demand database service environment need not include each device shown in FIGS. 2A and 2B or can include additional devices not shown in FIGS. 2A and 2B.

Additionally, it should be appreciated that one or more of the devices in the on-demand database service environment 200 can be implemented on the same physical device or on different hardware. Some devices can be implemented using hardware or a combination of hardware and software. Thus, terms such as “data processing apparatus,” “machine,” “server,” “device,” and “processing device” as used herein are not limited to a single hardware device; rather, references to these terms can include any suitable combination of hardware and software configured to provide the described functionality.

Cloud 204 is intended to refer to a data network or multiple data networks, often including the Internet. Client machines communicably connected with cloud 204 can communicate with other components of the on-demand database service environment 200 to access services provided by the on-demand database service environment. For example, client machines can access the on-demand database service environment to retrieve, store, edit, or process information. In some implementations, edge routers 208 and 212 route packets between cloud 204 and other components of the on-demand database service environment 200. For example, edge routers 208 and 212 can employ the Border Gateway Protocol (BGP). The BGP is the core routing protocol of the Internet. Edge routers 208 and 212 can maintain a table of Internet Protocol (IP) networks or ‘prefixes,’ which designate network reachability among autonomous systems on the Internet.

In some implementations, firewall 216 can protect the inner components of the on-demand database service environment 200 from Internet traffic. Firewall 216 can block, permit, or deny access to the inner components of on-demand database service environment 200 based upon a set of rules and other criteria. Firewall 216 can act as one or more of a packet filter, an application gateway, a stateful filter, a proxy server, or any other type of firewall.

In some implementations, core switches 220 and 224 are high-capacity switches that transfer packets within the on-demand database service environment 200. Core switches 220 and 224 can be configured as network bridges that quickly route data between different components within the on-demand database service environment. In some implementations, the use of two or more core switches 220 and 224 can provide redundancy or reduced latency.

In some implementations, pods 240 and 244 perform the core data processing and service functions provided by the on-demand database service environment. Each pod can include various types of hardware or software computing resources. An example of the pod architecture is discussed in greater detail with reference to FIG. 2B. In some implementations, communication between pods 240 and 244 is conducted via pod switches 232 and 236. Pod switches 232 and 236 can facilitate communication between pods 240 and 244 and client machines communicably connected with cloud 204, for example, via core switches 220 and 224. Also, pod switches 232 and 236 may facilitate communication between pods 240 and 244 and database storage 256. In some implementations, load balancer 228 can distribute workload between pods 240 and 244. Balancing the on-demand service requests between the pods can assist in improving the use of resources, increasing throughput, reducing response times, or reducing overhead. Load balancer 228 may include multilayer switches to analyze and forward traffic.

In some implementations, access to database storage 256 is guarded by a database firewall 248. Database firewall 248 can act as a computer application firewall operating at the database application layer of a protocol stack. Database firewall 248 can protect database storage 256 from application attacks such as SQL injection, database rootkits, and unauthorized information disclosure. In some implementations, database firewall 248 includes a host using one or more forms of reverse proxy services to proxy traffic before passing it to a gateway router. Database firewall 248 can inspect the contents of database traffic and block certain content or database requests. Database firewall 248 can work on the SQL application level atop the TCP/IP stack, managing applications' connection to the database or SQL management interfaces as well as intercepting and enforcing packets traveling to or from a database network or application interface.

In some implementations, communication with database storage 256 is conducted via database switch 252. Multi-tenant database storage 256 can include more than one hardware or software components for handling database queries. Accordingly, database switch 252 can direct database queries transmitted by other components of the on-demand database service environment (for example, pods 240 and 244) to the correct components within database storage 256. In some implementations, database storage 256 is an on-demand database system shared by many different organizations as described above with reference to FIGS. 1A and 1B.

FIG. 2B shows a system diagram further illustrating example architectural components of an on-demand database service environment according to some implementations. Pod 244 can be used to render services to a user of on-demand database service environment 200. In some implementations, each pod includes a variety of servers or other systems. Pod 244 includes one or more content batch servers 264, content search servers 268, query servers 282, file servers 286, access control system (ACS) servers 280, batch servers 284, and app servers 288. Pod 244 also can include database instances 290, quick file systems (QFS) 292, and indexers 294. In some implementations, some or all communication between the servers in pod 244 can be transmitted via pod switch 236.

In some implementations, app servers 288 include a hardware or software framework dedicated to the execution of procedures (for example, programs, routines, scripts) for supporting the construction of applications provided by on-demand database service environment 200 via pod 244. In some implementations, the hardware or software framework of an app server 288 is configured to execute operations of the services described herein, including performance of the blocks of various methods or processes described herein. In some alternative implementations, two or more app servers 288 can be included and cooperate to perform such methods, or one or more other servers described herein can be configured to perform the disclosed methods.

In an embodiment, one or more of restore manager 404 and restore plan manager 410, as described below, are executed by app servers 288.

Content batch servers 264 can handle requests internal to the pod. Some such requests can be long-running or not tied to a particular customer. For example, content batch servers 264 can handle requests related to log mining, cleanup work, and maintenance tasks. Content search servers 268 can provide query and indexer functions. For example, the functions provided by content search servers 268 can allow users to search through content stored in the on-demand database service environment. File servers 286 can manage requests for information stored in file storage 298. File storage 298 can store information such as documents, images, and binary large objects (BLOBs). In some embodiments, file storage 298 is a shared storage. By managing requests for information using file servers 286, the image footprint on the database can be reduced. Query servers 282 can be used to retrieve information from one or more file systems. For example, query servers 282 can receive requests for information from app servers 288 and transmit information queries to network file systems (NFS) 296 located outside the pod.

Pod 244 can share a database instance 290 configured as a multi-tenant environment in which different organizations share access to the same database. Additionally, services rendered by pod 244 may call upon various hardware or software resources. In some implementations, ACS servers 280 control access to data, hardware resources, or software resources. In some implementations, batch servers 284 process batch jobs, which are used to run tasks at specified times. For example, batch servers 284 can transmit instructions to other servers, such as app servers 288, to trigger the batch jobs.

In some implementations, QFS 292 is an open source file system available from Sun Microsystems, Inc. The QFS can serve as a rapid-access file system for storing and accessing information available within the pod 244. QFS 292 can support some volume management capabilities, allowing many disks to be grouped together into a file system. File system metadata can be kept on a separate set of disks, which can be useful for streaming applications where long disk seeks cannot be tolerated. Thus, the QFS system can communicate with one or more content search servers 268 or indexers 294 to identify, retrieve, move, or update data stored in NFS 296 or other storage systems.

In some implementations, one or more query servers 282 communicate with the NFS 296 to retrieve or update information stored outside of the pod 244. NFS 296 can allow servers located in pod 244 to access information to access files over a network in a manner similar to how local storage is accessed. In some implementations, queries from query servers 282 are transmitted to NFS 296 via load balancer 228, which can distribute resource requests over various resources available in the on-demand database service environment. NFS 296 also can communicate with QFS 292 to update the information stored on NFS 296 or to provide information to QFS 292 for use by servers located within pod 244.

In some implementations, the pod includes one or more database instances 290. Database instance 290 can transmit information to QFS 292. When information is transmitted to the QFS, it can be available for use by servers within pod 244 without using an additional database call. In some implementations, database information is transmitted to indexer 294. Indexer 294 can provide an index of information available in database instance 290 or QFS 292. The index information can be provided to file servers 286 or QFS 292. In some embodiments, there may be a plurality of database instances stored and accessed throughout the system. In some embodiments, user requests are received to restore at least a portion of one or more database instances 290 from a backup store (e.g., files in file storage 298).

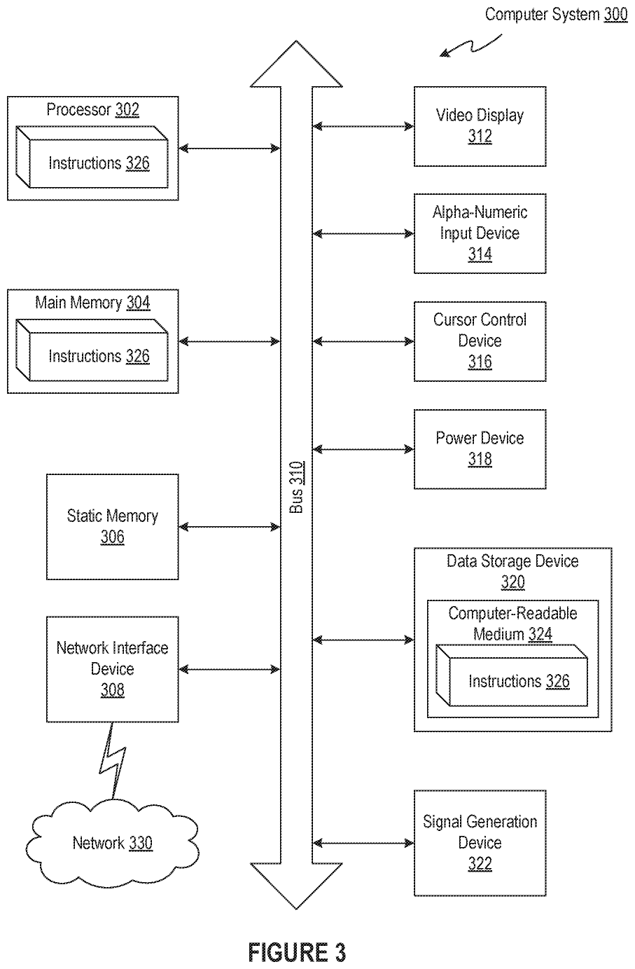

FIG. 3 illustrates a diagrammatic representation of a machine in the exemplary form of a computer system 300 within which a set of instructions (e.g., for causing the machine to perform any one or more of the methodologies discussed herein) may be executed. In alternative implementations, the machine may be connected (e.g., networked) to other machines in a LAN, a WAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a PDA, a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Some or all of the components of the computer system 300 may be utilized by or illustrative of any of the electronic components described herein (e.g., any of the components illustrated in or described with respect to FIGS. 1A, 1B, 2A, and 2B).

The exemplary computer system 300 includes a processing device (processor) 302, a main memory 304 (e.g., ROM, flash memory, dynamic random access memory (DRAM) such as synchronous DRAM (SDRAM) or Rambus DRAM (RDRAM), etc.), a static memory 306 (e.g., flash memory, static random access memory (SRAM), etc.), and a data storage device 320, which communicate with each other via a bus 310.

Processor 302 represents one or more general-purpose processing devices such as a microprocessor, central processing unit, or the like. More particularly, processor 302 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 302 may also be one or more special-purpose processing devices such as an application specific integrated circuit (ASIC), a field programmable gate array (FPGA), a digital signal processor (DSP), network processor, or the like. Processor 302 is configured to execute instructions 326 for performing the operations and steps discussed herein. Processor 302 may have one or more processing cores.

Computer system 300 may further include a network interface device 308. Computer system 300 also may include a video display unit 312 (e.g., a liquid crystal display (LCD), a cathode ray tube (CRT), or a touch screen), an alphanumeric input device 314 (e.g., a keyboard), a cursor control device 316 (e.g., a mouse or touch screen), and a signal generation device 322 (e.g., a loud speaker).

Power device 318 may monitor a power level of a battery used to power computer system 300 or one or more of its components. Power device 318 may provide one or more interfaces to provide an indication of a power level, a time window remaining prior to shutdown of computer system 300 or one or more of its components, a power consumption rate, an indicator of whether computer system is utilizing an external power source or battery power, and other power related information. In some implementations, indications related to power device 318 may be accessible remotely (e.g., accessible to a remote back-up management module via a network connection). In some implementations, a battery utilized by power device 318 may be an uninterruptable power supply (UPS) local to or remote from computer system 300. In such implementations, power device 318 may provide information about a power level of the UPS.

Data storage device 320 may include a tangible computer-readable storage medium 324 (e.g., a non-transitory computer-readable storage medium) on which is stored one or more sets of instructions 326 (e.g., software) embodying any one or more of the methodologies or functions described herein. Instructions 326 may also reside, completely or at least partially, within main memory 304 and/or within processor 302 during execution thereof by computer system 300, main memory 304, and processor 302 also constituting computer-readable storage media. Instructions 326 may further be transmitted or received over a network 330 (e.g., network 14) via network interface device 308.

In one implementation, instructions 326 include instructions for performing any of the implementations of restore manager 404 and/or restore plan manager 410 as described herein. While computer-readable storage medium 324 is shown in an exemplary implementation to be a single medium, it is to be understood that computer-readable storage medium 324 may include a single medium or multiple media (e.g., a centralized or distributed database, and/or associated caches and servers) that store the one or more sets of instructions.

Embodiments of the present invention improve the predictable DB restore time by routinely and periodically performing (otherwise unnecessary) restores to continually assess the validity of each backup artifact, and thus determine the probability that a DB restore operation introduces corruption into the restore. Because continually testing each artifact is computationally expensive, embodiments described herein provide a process that will test a statistically meaningful subset of restores to confidently predict the probability of encountering a corrupted artifact of a particular type during a DB restore. These probabilities are then used to generate an optimized restore plan for the DB when a request to restore the DB is received.

As used herein, an artifact is an opaque file with some metadata associated with it. In some embodiments, the artifact is to be distributed in the cloud computing environment. In various examples, an artifact is a binary file (e.g., compiled application, OS component, DB system component, docker, code image, zip file, compressed file, etc.) or a configuration file (e.g., a text file such as a Yet Another Markup Language (YAML) describing a manifest or a network configuration file, etc.). An artifact may also be a data file containing text data, image data, audio data, video data, audio data, multimedia data, DB data, or other data in any format. Furthermore, the artifact may be of any size (e.g., from the low kilobytes (KBs) to many gigabytes (GBs). In some embodiments, a plurality of artifacts is stored in a DB (such as tenant database 22 and/or system database 24 of FIGS. 1A and 1B).

Artifact corruptions are generally rare. Known DB systems provide backup and restore capabilities that do not usually incorporate corruption analysis in determining restore processes. However, when managing thousands to millions of database backups, rare corruptions of artifacts can materially impact cloud computing environment operations. Some circumstances increase the rate of corruption. Since artifact corruptions can vary as a function of the version of the software and hardware used, as well as usage pattern, embodiments of the present invention collectively track the corruption probability of databases using the same version of software and hardware and the same DB application.

For example, consider the following specific use case. Assume a request is received (perhaps from a user 12 of FIG. 1) to restore a particular database within tenant database 22 to January 20 at 8:00 am. Assume also for example purposes that a full backup of the database was completed at 12:00 am on January 1, incremental backups were performed for each day in January, and all the redo logs were completed for the month of January. A redo log is a recording of every database update operation performed in time-ordered sequence and written to the database's primary storage system. In an embodiment, a redo log is generated every hour. Let's assume database system 16 of FIG. 1 takes 20 hours to restore a full backup, 4 hours to apply each incremental backup, and ½ hour to apply each hour of the redo logs.

Since restoring a database is an important feature of cloud computing to compensate for data storage failures, data center failures, and user operator failures, embodiments of the present invention archive redundant forms of the database, archiving both the transactional record (e.g., redo logs), which is “replayed” to restore an old database image to a more recent state, as well as snapshots of the database storage blocks from various times. A full backup contains a snapshot of every database storage block, while an incremental backup only contains the blocks that changed since the last backup. Thus, there are multiple combinations of restore operations by which the database can be restored. Let's examine three options to illustrate the model of embodiments of the present invention.

Option 1—Apply the January 1 full backup and then 464 instances (19 days×24 hours+8 hours) of redo logs. The total DB restore time equals 20 hours for the full backup plus 232 hours for applying the redo logs (a total of 252 hours).

Option 2—Apply the January 1 full backup, 9 incremental backups through January 10, and then 248 instances (10 days×24 hours+8 hours) of redo logs. The total DB restore time equals 20 hours for the full backup plus 36 hours (9×4 hours) for the incremental backups, plus 124 hours for applying the redo logs (a total of 180 hours).

Option 3—Apply the January 1 full backup, 19 incremental backups through January 20, and then 8 instances of redo logs. The total DB restore time is 20 hours for the full, plus 76 hours (19×4 hours) for the incremental backups, plus 4 hours for applying the redo logs (a total of 100 hours).

At first glance, it may appear that Option 3 would always be the preferred approach since the total restore time is the lowest. However, in embodiments of the present invention probabilities of corruption of artifacts is also taken into account when determining the best restore process.

Consider, for example, a corruption probability that restoring each incremental backup can add a 5% probability of corruption of the entire DB restore. In this scenario, Option 1 has a 0% chance of failure (since no incremental backups were used in the DB restore). Option 2 has an approximately 37% change of failure (based on the 5% error probability for each of the incremental backups). Option 3 has an approximately 62% chance of failure (based on the 5% error probability for each of the incremental backups). Option 3 is faster than options 1 and 2, but potentially more problematic with respect to corruption. Option 2 is faster than option 1 and has a higher probability of corruption than option 1, but less than option 3. In many cases, the corruption of the DB restore cannot be detected until the end of the restore process. If at the end of running option 3 a failure is detected, in an embodiment the DB restore is restarted with option 2. If at the end of running option 2 a failure is detected, in an embodiment the DB restore is restarted with option 1.

Accounting for probabilities of potential failures, the expected completion times are as follows:
Expect time for Option 1 remains 252 hours.
Expected time for Option 2 is now 180 hours+37%×252 hours=273 hours.
Expected time for Option 3 is now 100 hours+62%×180 hours+37%×252 hours=305 hours.
   In this simple example, the best expected completion time is option 1. If the probability of incremental backup corruption were lower, option 2 would be the fastest. If there are very low incremental backup corruption rates, option 3 would be fastest. Although three options are shown in this simple example, in practice there may be many options and there may be different corruption rates for full backups, incremental backups, and redo logs.

For real world databases in use in large scale cloud computing environments, there may be large numbers of databases, varying sizes of databases, varying times needed for restoring full backups, incremental backups, and redo logs, varying corruption rates for different databases, different sets of software and hardware used for the databases, varying computational loads on the cloud computing environment, and other factors. By incorporating the actual corruption incident measurement and probability in each specific environment of hardware and software versions, specific workload, and specific environment, into the DB restore option selection calculation, the speed of DB restore operations can be improved and optimized for each specific condition. In this example, the corruption from incremental restores is measured. However, corruption can occur in any type of operation. Embodiments of the present invention can be used to optimize DB recovery time in any corruption scenario. The model can be generalized to adapt to corruption and other failures introduced into any artifact and any specific scenario.

Embodiments of the present invention enhance a DB restoration service by adding a restore plan manager that predicts a fastest successful restore process based on historical restore outcomes (and associated artifact corruption probabilities). There are two modes of operation. In the first mode, the recovery outcome information (e.g., successful or failed DB restore, the combination of DB archive artifacts used, and the versions of software and hardware, etc.) for a DB restore is collected by a restore manager and delivered to the restore plan manager for storage. In the second mode, the restore manager obtains a restore plan from the restore plan manager, which uses the historical restore outcome information previously collected to predict (and thus select) the best DB restore plan. In one embodiment, the best database restore plan is the one with the best chance of success in the least amount of time as compared to other restore plans.

FIG. 4 is a diagram of an example database restore system 400 according to some embodiments. Restore request 402 is received from a user or a system administrator to direct database system 16 to restore a selected database (e.g., tenant database 22) to a specified point in time. Restore manager 404 fields the restore request and calls get restore plan function 412 in restore plan manager 410. Get restore plan 412 gets previously stored restore outcomes 418, analyzes error probabilities of full backups, incremental backups, and redo logs, and determines a best restore plan. Restore plan manager 410 sends the restore plan to restore manager 404. Restore manager 404 uses the restore plan 414 to perform the requested DB restore operation. In an embodiment, restore manager 404 gets one or more of full backups, incremental backups, and/or redo logs from DB archives 406. DB archives 406 stores versions of full backups, incremental backups, and/or redo logs when database system 16 backs up tenant databases 16. Restore manager 404 generates one or more restored DBs 408 based at least in part on restore plan 414 and DB archives 406. Once the requested DB is restored, restore manager determines a best restore outcome (e.g., success or failure (if one or more artifacts of the restored DB are corrupted). Restore manager 404 calls save restore outcome function 416 of restore plan manager 416 to save the restore outcome information in restore outcomes 418.

In an embodiment, restore plan manager 410 and restore manager 404 are implemented as part of application platform 18 of FIG. 1A, application server 100₁ . . . 100_{N} of FIG. 1B, or app server 288 of FIG. 2B. In one embodiment, the functionality of restore plan manager 410 and restore manager 404 are combined into one software component.

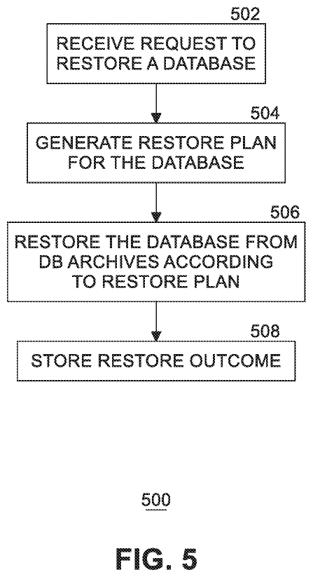

FIG. 5 is a flow diagram of example processing 500 in a database restore system 400 according to some embodiments. At block 502, restore manager 404 receives a request to restore a database. At block 504, restore plan manager generates a best restore plan 414 for the database based at least in part on previous restore outcomes 418 of databases matching one or more characteristics of the database requested to be restored (e.g., software version, hardware used, and so on). At block 506, restore manager 404 restores the database from DB archives 406 into restored DBs 408 according to the restore plan 414. At block 508, restore manager 404 and restore plan manager 410 store the restore outcome 418 (e.g., success or failure (due to artifact corruption)). The actions may be periodically repeated for one or more databases to refine restore plans with continually updated restore outcomes (and associated error probabilities).

Example pseudocode for implementing a get restore plan function 412 by restore plan manager 410 is shown below.

Copyright © 2020, salesforce.com, inc., All Rights Reserved.
Function GetRestorePlan (restorePoint, versionData) {

lastFullBackup = GetLastFullBackupBefore (RestorePoint);
dailyIncrementalSet[ ] = GetDailyIncrementalBackupSetBetween

(RestorePoint, LastFullBackup);

OptimalBackupTime = infinite;
For each (incremental in Incremental Set) {

/* calculate the total restore time if all goes well */
BestTimeToRestore = Time (lastFullBackup) +

Time (incremental) +
Time (redoBetween (incremental, restorePoint);

/* get the probability this incremental will fail */
Prob = GetFailProbability(incremental, LastFullBackup);
/* calculate the time to restore if the incremental restore fails
* and have to use the slow-but-dependable all-redo from
* the last full backup to restorePoint. */
alternativeTimeToRestore = Time (lastFullBackup) +

Time (redoBetween (lastFullbackup, restorePoint);

/* calculate total expected time by taking the
* the time for slow-but-dependable restore and multiply
* that by the probability of need to use it, and then add
* that to the restore time if all goes well. */
finalExpectedTime = BestTimeToRestore +

Prob * alternativeTimeToRestore;

/* If this incremental has the fastest expected time, let's
* go with this. */
If finalExpectedTime < OptimalBackupTime then {

OptimalBackupTime = finalExpectedTime;
restorePlan = incremental; /* this is the best plan */

} /*end if*/

}/*end of for each loop */
Return restorePlan; /* the fastest expected restore time */

} /*end of function */

In another embodiment of this invention, a heuristic is used that collects DB restore operation failure rates, both specific to a given configuration of hardware and software, as well as general failures, and then predicts failure probability for each data restore method. That prediction drives the restore plan 414 to follow the predicted fastest reliable restore process. This embodiment will still collect the actual failure rates so that the system gains accuracy in restore failure predictions.

In another embodiment of this invention, the process to follow for restoring any given database is determined by using machine learning to train a neural network. This embodiment will use a corpus of all previous restore attempts, configurations, and outcomes to train a neural network. The input to the neural network will include among other relevant information, the hardware and software configuration, all version information, the date and time, the restore options, and the eventual outcome. The output from the neural network will be the restore plan 414 recommendation.

Examples of systems, apparatuses, computer-readable storage media, and methods according to the disclosed implementations are described in this section. These examples are being provided solely to add context and aid in the understanding of the disclosed implementations. It will thus be apparent to one skilled in the art that the disclosed implementations may be practiced without some or all the specific details provided. In other instances, certain process or method operations, also referred to herein as “blocks,” have not been described in detail in order to avoid unnecessarily obscuring the disclosed implementations. Other implementations and applications also are possible, and as such, the following examples should not be taken as definitive or limiting either in scope or setting.

In the detailed description, references are made to the accompanying drawings, which form a part of the description and in which are shown, by way of illustration, specific implementations. Although these disclosed implementations are described in sufficient detail to enable one skilled in the art to practice the implementations, it is to be understood that these examples are not limiting, such that other implementations may be used and changes may be made to the disclosed implementations without departing from their spirit and scope. For example, the blocks of the methods shown and described herein are not necessarily performed in the order indicated in some other implementations. Additionally, in some other implementations, the disclosed methods may include more or fewer blocks than are described. As another example, some blocks described herein as separate blocks may be combined in some other implementations. Conversely, what may be described herein as a single block may be implemented in multiple blocks in some other implementations. Additionally, the conjunction “or” is intended herein in the inclusive sense where appropriate unless otherwise indicated; that is, the phrase “A, B, or C” is intended to include the possibilities of “A,” “B,” “C,” “A and B,” “B and C,” “A and C,” and “A, B, and C.”

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion.

In addition, the articles “a” and “an” as used herein and in the appended claims should generally be construed to mean “one or more” unless specified otherwise or clear from context to be directed to a singular form. Reference throughout this specification to “an implementation,” “one implementation,” “some implementations,” or “certain implementations” indicates that a particular feature, structure, or characteristic described in connection with the implementation is included in at least one implementation. Thus, the appearances of the phrase “an implementation,” “one implementation,” “some implementations,” or “certain implementations” in various locations throughout this specification are not necessarily all referring to the same implementation.

Some portions of the detailed description may be presented in terms of algorithms and symbolic representations of operations on data bits within a computer memory. These algorithmic descriptions and representations are the manner used by those skilled in the data processing arts to most effectively convey the substance of their work to others skilled in the art. An algorithm is herein, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, or otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving,” “retrieving,” “transmitting,” “computing,” “generating,” “adding,” “subtracting,” “multiplying,” “dividing,” “optimizing,” “calibrating,” “detecting,” “performing,” “analyzing,” “determining,” “enabling,” “identifying,” “modifying,” “transforming,” “applying,” “aggregating,” “extracting,” “registering,” “querying,” “populating,” “hydrating,” “updating,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission, or display devices.

The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects. Additionally, while the disclosed examples are often described herein with reference to an implementation in which a computing environment is implemented in a system having an application server providing a front end for an on-demand database service capable of supporting multiple tenants, the present implementations are not limited to multi-tenant databases or deployment on application servers. Implementations may be practiced using other database architectures, i.e., ORACLE®, DB2® by IBM, and the like without departing from the scope of the implementations claimed. Moreover, the implementations are applicable to other systems and environments including, but not limited to, client-server models, mobile technology and devices, wearable devices, and on-demand services.

It should also be understood that some of the disclosed implementations can be embodied in the form of various types of hardware, software, firmware, or combinations thereof, including in the form of control logic, and using such hardware or software in a modular or integrated manner. Other ways or methods are possible using hardware and a combination of hardware and software. Any of the software components or functions described in this application can be implemented as software code to be executed by one or more processors using any suitable computer language such as, for example, C, C++, Java™, or Python using, for example, existing or object-oriented techniques. The software code can be stored as non-transitory instructions on any type of tangible computer-readable storage medium (referred to herein as a “non-transitory computer-readable storage medium”). Examples of suitable media include random access memory (RAM), read-only memory (ROM), magnetic media such as a hard-drive or a floppy disk, or an optical medium such as a compact disc (CD) or digital versatile disc (DVD), flash memory, and the like, or any combination of such storage or transmission devices. Computer-readable media encoded with the software/program code may be packaged with a compatible device or provided separately from other devices (for example, via Internet download). Any such computer-readable medium may reside on or within a single computing device or an entire computer system and may be among other computer-readable media within a system or network. A computer system, or other computing device, may include a monitor, printer, or other suitable display for providing any of the results mentioned herein to a user.

The disclosure also relates to apparatuses, devices, and system adapted/configured to perform the operations herein. The apparatuses, devices, and systems may be specially constructed for their required purposes, may be selectively activated or reconfigured by a computer program, or some combination thereof.

In the foregoing description, numerous details are set forth. It will be apparent, however, to one of ordinary skill in the art having the benefit of this disclosure, that the present disclosure may be practiced without these specific details. While specific implementations have been described herein, it should be understood that they have been presented by way of example only, and not limitation. The breadth and scope of the present application should not be limited by any of the implementations described herein but should be defined only in accordance with the following and later-submitted claims and their equivalents. Indeed, other various implementations of and modifications to the present disclosure, in addition to those described herein, will be apparent to those of ordinary skill in the art from the foregoing description and accompanying drawings. Thus, such other implementations and modifications are intended to fall within the scope of the present disclosure.

Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein, along with the full scope of equivalents to which such claims are entitled.

What is claimed is:

1. A computer-implemented method comprising:
receiving a request to restore a database in a cloud computing environment;
generating a restore plan for the database based at least in part on previously stored database restore outcomes and error probabilities of full backups, incremental backups, and redo logs;
restoring the database from an archive according to the restore plan; and
storing an outcome of the database restore.

2. The computer-implemented method of claim 1, comprising:
periodically repeating restoring one or more databases to refine restore plans with continually updated restore outcomes.

3. The computer-implemented method of claim 1, comprising:
predicting a probability of encountering a corrupted artifact of a particular type during the database restore based at least in part on stored restore outcomes.

4. The computer-implemented method of claim 1, comprising:
generating the restore plan based at least in part on a corruption probability of a version of database software used for a database backup and computing hardware of the cloud computing environment used to perform the database backup.

5. The computer-implemented method of claim 1, wherein generating the restore plan comprises predicting a fastest successful database restore process based on historical restore outcomes.

6. The computer-implemented method of claim 1, wherein the generated restore plan has a best chance of success in a least amount of time as compared to other restore plans.

7. A tangible, non-transitory computer-readable storage medium having instructions stored thereon which, when executed by a processing device, cause the processing device to:
receive a request to restore a database in a cloud computing environment;
generate a restore plan for the database based at least in part on previously stored database restore outcomes and error probabilities of full backups, incremental backups, and redo logs;
restore the database from an archive according to the restore plan; and
store an outcome of the database restore.

8. The tangible, non-transitory computer-readable storage medium of claim 7, having instructions stored thereon which, when executed by the processing device, cause the processing device to:
periodically repeat restoring one or more databases to refine restore plans with continually updated restore outcomes.

9. The tangible, non-transitory computer-readable storage medium of claim 7, having instructions stored thereon which, when executed by the processing device, cause the processing device to:
predict a probability of encountering a corrupted artifact of a particular type during the database restore based at least in part on stored restore outcomes.

10. The tangible, non-transitory computer-readable storage medium of claim 7, having instructions stored thereon which, when executed by the processing device, cause the processing device to:
generate the restore plan based at least in part on a corruption probability of a version of database software used for a database backup and computing hardware of the cloud computing environment used to perform the database backup.

11. The tangible, non-transitory computer-readable storage medium of claim 7, wherein instructions to generate the restore plan comprise instructions to predict a fastest successful database restore process based on historical restore outcomes.

12. The tangible, non-transitory computer-readable storage medium of claim 7, wherein the generated restore plan has a best chance of success in a least amount of time as compared to other restore plans.

13. A system comprising:
a restore manager to receive a request to restore a database in a cloud computing environment; and
a restore plan manager to generate a restore plan for the database based at least in part on previously stored database restore outcomes and error probabilities of full backups, incremental backups, and redo logs;
wherein the restore manager is to restore the database from an archive according to the restore plan; and
wherein the restore plan manager is to store an outcome of the database restore.

14. The system of claim 13, wherein the restore manager is to periodically repeat restoring one or more databases to refine restore plans with continually updated restore outcomes.

15. The system of claim 13, wherein the restore plan manager is to predict a probability of encountering a corrupted artifact of a particular type during the database restore based at least in part on stored restore outcomes.

16. The system of claim 13, wherein the restore plan manager is to generate the restore plan based at least in part on a corruption probability of a version of database software used for a database backup and computing hardware of the cloud computing environment used to perform the database backup.

17. The system of claim 13, wherein the restore plan manager is to generate the restore plan by predicting a fastest successful database restore process based on historical restore outcomes.

18. The system of claim 13, wherein the generated restore plan has a best chance of success in a least amount of time as compared to other restore plans.
